(19) United States
(12) Patent Application Publication
(10) Pub. No.: US 2005/0260111 A1
(43) Pub. Date: Nov. 24, 2005

(54) DRILLING MUD REMEDIATION

(76) Inventors: Norman Arrison, Edmonton, Alberta (CA); Earl Gingras, Edmonton, Alberta (CA); James Kruhnen, Red Deer, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/908,630

(22) Filed: May 19, 2005

Related U.S. Application Data
(60) Provisional application No. 60/521,548, filed on May 20, 2004.

(51) Int. Cl. B01D 21/00

(52) U.S. Cl. 422/233; 422/198

(57) ABSTRACT

A method and apparatus for removing liquids from spent drilling fluid solids includes a horizontally elongate separator having an augur with a discontinuous blade. The solids are heated to drive off volatile liquids, which are then collected and condensed. An internal combustion engine may actuate a generator and the exhaust gases used as a heat source, as well as electric heating elements. The exhaust gases may be introduced into the separator directly, through a heating channel or through a hollow augur shaft. Uncondensed gases may be treated to reduce particulate and gas emissions.

### CROSS REFERENCE TO RELATED APPLICATIONS

This application claims the priority benefit of U.S. Provisional Patent Application No. 60/521,548 filed on May 20, 2004 entitled “Drilling Mud Remediation”, the contents of which are incorporated herein by reference.

### FIELD OF INVENTION

The present invention relates to a method and apparatus for the remediation of drilling mud. In particular, it relates to a method and apparatus for cleaning solids contaminated with volatile liquids and recovering the cleaned solids and volatile liquids.

### BACKGROUND OF THE INVENTION

Drilling fluid, commonly referred to as drilling mud, is circulated through an oil well during the drilling process and performs many important functions. Drilling mud typically has a light oil base, such as a diesel oil.

As drilling mud is circulated back to the surface, it is common to process the drilling mud with shale shakers, desanders, and desilters to help remove cuttings and other solid impurities from the drilling mud. The cuttings and other solids removed from drilling mud are often contaminated with oil, diesel, and other hydrocarbons. Because of environmental concerns, it is not possible to dispose of such solids without first decontaminating them.

A variety of techniques and equipment are utilized or have been suggested for dealing with this problem such as the use of surfactants, solvents, and thermal operations to vaporize the hydrocarbons. Each of these methods and the equipment implementing the methods have proven unsatisfactory for various reasons.

Therefore there is a need in the art for an apparatus to separately recover the solids, water, hydrocarbon components and other impurities of contaminated solids recovered from used drilling mud.

### SUMMARY OF THE INVENTION

In one aspect, the invention comprises an apparatus for cleaning particulate solids mixed with at least one liquid, which may be a hydrocarbon contaminant such as a diesel oil. In one embodiment, the invention comprises an apparatus comprising:
(a) an elongate separator defining a longitudinal solids channel and a longitudinal heating channel, said solids channel having a solids inlet at one end and a solids outlet at a second end;
(b) an internal combustion engine with an exhaust, the exhaust being connected to the longitudinal heating channel by means of an exhaust gas conduit;
(c) an auger having a centre shaft rotatably disposed within the solids channel, wherein said centre shaft is hollow and wherein said hollow centre shaft is connected to the longitudinal heating channel or the exhaust gas conduit at one end;
(d) means for rotating the auger;
(e) means for collecting and condensing vapour and gases from the solids channel.

In one embodiment the hollow centre shaft defines a plurality of openings along its length. In another embodiment, the means for collecting and condensing the vapour and gases from the solids channel comprises a vapour outlet in the solids channel, a pump and a receiving tank for collecting condensate, gases and vapours from the pump. In an embodiment the pump is a cone jet pump. In a further embodiment, the receiving tank has an internal cooler, at least one fluid outlet, and a gas outlet. In one embodiment, the auger comprises a discontinuous blade disposed about the centre shaft, and in a further embodiment the discontinuous blade comprises a plurality of paddles angled relative to a plane perpendicular to a longitudinal axis of the auger.

In an embodiment the apparatus also has a gas scrubbing system for scrubbing gases and vapours leaving the gas outlet in the receiving tank with a caustic solution.

In another aspect of the invention, the invention comprises an apparatus for cleaning particulate solids mixed with a liquid hydrocarbon comprising:
(a) an elongate separator having a solids inlet at one end and a solids outlet at a second end;
(b) means for heating the separator;
(c) an auger disposed within the separator, said auger comprising a discontinuous blade;
(d) means for rotating the auger;
(e) a vapour outlet for collecting and removing gases and vapours from within the separator.

In another aspect, the invention may comprise a method of cleaning particulate solids mixed with a liquid hydrocarbon, comprising the steps of:
(a) providing an elongate separator defining a solids channel and having an augur disposed within the channel;
(b) actuating the augur to push solids through the solids channel while heating the solids at the same time to produce hydrocarbon vapour, wherein the solids are heated directly or indirectly by exhaust gas from an internal combustion engine or electrical heating elements or both;
(c) collecting the hydrocarbon vapour by creating a partial vacuum within the solids channel and quenching the vapour with a water spray;
(d) collecting uncondensed gases and liquids from step (c), and separately collecting liquid hydrocarbons and water;
(e) recirculating water from step (d) to step (c).

Other embodiments of the invention may not include all of these elements and may provide different combinations of these elements, or substitute certain of these elements.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a schematic representation of one embodiment of a system of the present invention.

FIG. 2 is an end perspective view of the separator.

FIG. 3 is a view of one embodiment of the auger.

FIG. 4 is a schematic depiction of the cone jet pump.

### DETAILED DESCRIPTION OF THE INVENTION

The present invention provides for an apparatus for the remediation of drilling mud and the cleaning of drilling mud solids in particular. When describing the present invention, all terms not defined herein have their common art-recognized meanings.

While the invention may be described in relation to processing solids from drilling fluids contaminated with water and hydrocarbons, one skilled in the art may recognize that the invention may be used in connection with any particulate solid matter (referred to herein as “solids”) which is mixed with at least one liquid. As used herein, the terms “gases” and “vapours” may be used interchangeably.

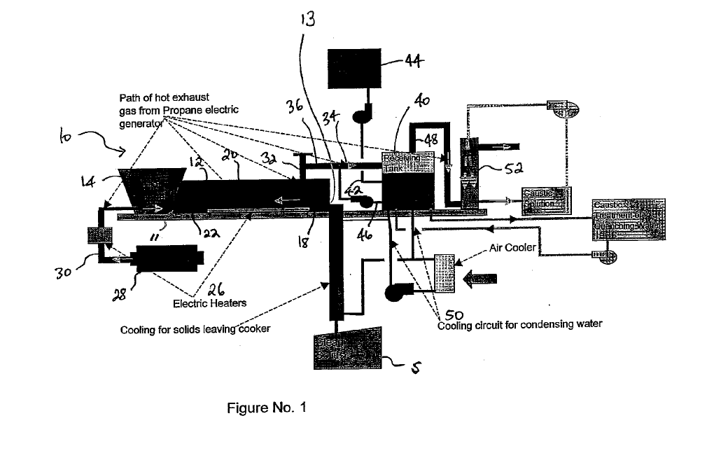

As depicted in FIG. 1, in a basic embodiment, the invention comprises an elongated hollow separator (10) having a solids inlet (11) at one end and a solids outlet at the other end (13). The separator (10) has a longitudinal solids channel (24) and longitudinal heat channel (22) which is separated from the solids channel by an internal divider. An auger (12) is disposed within the solids channel (24) to push solids through the solids channel (24) within the separator (10) from the end of the separator (10) having the solids inlet (11) to the other end of the separator (10) having the solids outlet (13). As used herein, an auger may comprise a screw auger or any other elongate device which causes the solids to move within the separator (10) when actuated. A feed hopper (14) feeds solids to be treated into the separator (10) through the solids inlet (11). Dried and cleaned solids (S) may be recovered at the other end of the separator (10) through the solids outlet (13). In operation, if the solids are fed into the separator at a less than maximum rate, the solids will occupy a lower portion of the solids channel (24), providing a vapour headspace above the solids.

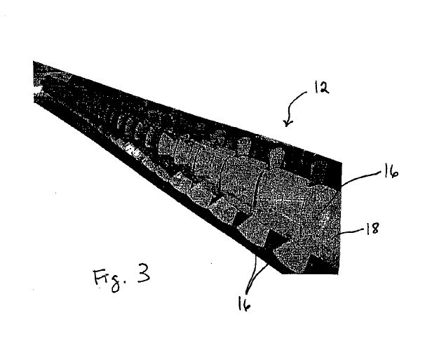

In a preferred embodiment, the auger (12) may comprise a plurality of paddle blades (16) which are angled in a plane perpendicular to the longitudinal axis of the auger (12) so as to push solids longitudinally through the solids channel (24) when the auger (12) rotates. The inventors have found that a plurality of paddle blades (16) may be more effective in moving a wet mass of particulate solids than a continuous helical screw auger. As shown in FIG. 3, the paddle blades (16) may be arrayed about the auger centre shaft (18) so as to approximate a helical inclined plane about the auger centre shaft (18). As used herein, the term “discontinuous blade” shall refer to any attachment disposed on the auger shaft (18) which causes movement of the wet solids when the auger shaft (18) rotates, which attachment is not a continuous helical blade. Therefore, a discontinuous blade may comprise a plurality of paddle blades as shown in FIG. 3. The auger may be activated by an electric motor, or an internal combustion engine, or any other suitable means known in the art.

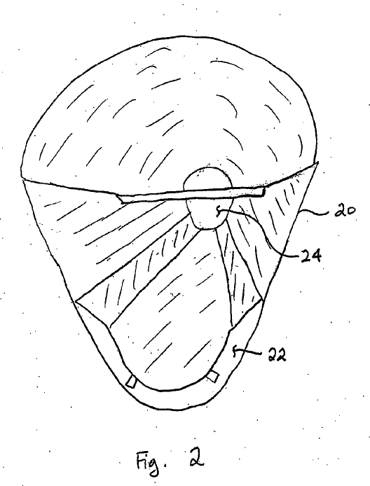

The separator (10) is heated so as to vapourize any liquid which is mixed with or bound to the solids. In one embodiment, multiple heat sources are provided. As shown in FIG. 2, the separator housing (20) may be used to define the heating channel (22) adjacent to the solids channel (24) through which heated air may be circulated. The auger (12) itself may also be heated. In one embodiment, the auger centre shaft (18) is hollow and may receive heated air either from the same source as the heating channel (22), or from the heating channel (22) itself. Alternatively, or additionally electrical heating elements (26) may be applied to the separator (10).

In one embodiment, an electrical generator (28) is powered by an internal combustion engine, such as a propane-powered or diesel engine. The combustion engine (28) exhaust gases are routed through an exhaust gas conduit (30) and into the heating channel (22) as a heat source. Alternatively the combustion engine (28) exhaust gases are routed through the exhaust gas conduit (30) and into the heating channel (22) and the hollow auger centre shaft (18). In a further alternative the exhaust gases pass into the heating channel (22) and then pass into the auger centre shaft (18). The auger centre shaft (18) itself may be open at one end or may comprise a plurality of openings (not shown in the Figures) such that the exhaust gases diffuse into the solid channel (10) heating and drying the solids contained therein. Feeding the exhaust gas into the separator (10) reduces the chances of explosion because the exhaust gas will have depleted oxygen levels and will displace normal atmospheric oxygen.

The electrical generator (28) may be used to energize the electrical heating elements (26). In one embodiment, electrical heating elements (26) are placed on or within separator housing (20) itself or on the exhaust gas conduit (30) between the generator engine and the separator (10), or both.

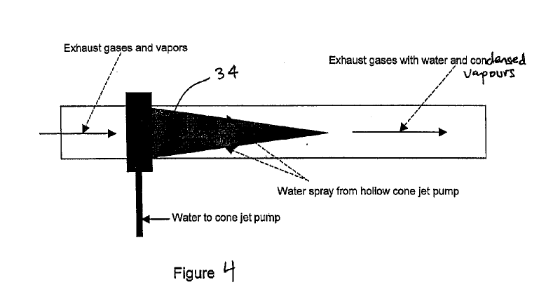

The separator housing (20) is preferably a gas-tight enclosure so that gases from within the separator (10) may be removed and treated. The gases may comprise exhaust gas from the electrical generator (28) motor, steam from water mixed with the solids, and vapourized hydrocarbons from liquid hydrocarbons mixed with the solids. In one embodiment, a vapour outlet (32) in the separator is provided in combination with a gas or multiphase pump (34) for removing gases and vapour from the separator (10). The gas pump may be a jet pump such as the cone jet pump (34) illustrated in FIG. 4. In a conventional jet pump, a high pressure fluid jet creates a venturi effect which draws another fluid into the fluid jet stream. Jet pumps are well known in the industry and need not be described in detail herein.

In one embodiment, vapours and gases from the separator (10) are sucked through the vapour outlet (32) into a pipe (36) connecting the separator (10) to a receiving tank (40) by a cone jet pump (34). A cone jet pump (34) includes a conical fluid jet spray. In one embodiment, the fluid jet stream may comprise a water jet spray which also serves to quench the gas and vapour stream exiting the separator (10) and condense a portion of the gas and vapour stream which contacts the water spray. The cone jet pump (34) assists in the condensation process as the vapors and gases are contacted with the cool water stream. The water, condensate, and uncondensed gases and vapours then enter the receiving tank (40) where they are collected.

There is further condensation of condensable gases and vapours in the receiving tank (40). In one example, if the solids being cleaned are used drilling mud solids mixed with diesel oil and water or brine, water and diesel oil will condense in the receiving tank (40) in separate layers. The receiving tank (40) may have one or more fluid outlets (42, 46) to drain the liquid comprising the condensed gases and vapours extracted from the separator (10). In particular, an oil outlet (42) may be provided to periodically drain off the recovered light oil from the receiving tank (40) into an oil storage tank (44) and a water outlet (46) may be provided from the bottom of the receiving tank (40). A gas outlet (48) may be provided at the top of the receiving tank (40) to draw off uncondensed and non-condensable gases and vapours. The receiving tank (40) may be cooled using an internal cooler (50) to further promote condensation of the vapours and gases and to cool the condensate. As shown in FIG. 1, the cooler may comprise an internal coil (50) through which a cooling fluid flows. In one embodiment, a portion of this cooling circuit may also be used to cool the solids (S) exiting the separator (10) via the solids outlet (13).

In one embodiment, the water collected in the receiving tank (40) may be used to power the jet pump (34), and is recirculated as shown schematically in FIG. 1. Thus, the water component condenses in the receiving tank (40), is pumped to provide the jet stream which powers the jet pump (34), and then returns to the receiving tank (40).

The water which is accumulates in the receiving tank (40) and recirculates through the jet pump will become acidic over time, due to the products of combustion which are present in the gas stream leaving the separator (10). Therefore, it is preferable to periodically remove and refresh the water supply. Alternatively or additionally, an acid neutralization system may be employed which adds a base to the recirculating water when the pH reaches a predetermined level. This system may be automated with a pH monitoring system, a reservoir of basic solution and an injection device. As well, it may be desirable or necessary to periodically remove the salts produced by acid neutralization. The salt build-up may be removed at periodic intervals by precipitation and physical removal or by the use of well-known techniques such as reverse osmosis.

The oil which is recovered in the oil storage tank (44) may be discarded as waste oil, cleaned and upgraded or used in an industrial process.

In a preferred embodiment, the gases and vapours leaving the receiving tank (40) through the gas outlet (48) may be treated to remove any residual particulate matter or to reduce unwanted emissions. Any liquid spray will remove fine solids still entrained in the gas and vapour stream. Additionally, in one embodiment, the gases and vapours may be scrubbed with a caustic solution spray to remove or neutralize oxides of nitrogen, sulphur or carbon dioxide. In one embodiment, the gases and vapours from the receiving tank (40) are discharged through a spray tower (52) to remove particulates and acid gases. The chemical treatment of the spray tower can be adjusted to meet any necessay requirements needed for air quality control. Various basic chemicals such as potassium hydroxide, sodium hydroxide, or other exhaust treating chemicals such as urea may be used in the spray tower in an effort to meet any desired emissions standards.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. An apparatus for cleaning particulate solids mixed with a liquid hydrocarbon comprising:
(a) an elongate separator defining a longitudinal solids channel and a longitudinal heating channel, said solids channel having a solids inlet at one end and a solids outlet at a second end;
(b) an internal combustion engine with an exhaust, the exhaust being connected to the longitudinal heating channel by means of an exhaust gas conduit;
(c) an auger having a centre shaft rotatably disposed within the solids channel, wherein said centre shaft is hollow and wherein said hollow centre shaft is connected to the longitudinal heating channel at one end;
(d) means for rotating the auger;
(e) means for collecting and condensing vapour and gases from the solids channel.

2. The apparatus of claim 1 wherein the hollow centre shaft defines a plurality of openings along its length.

3. The apparatus of claim 1 wherein the means for collecting and condensing the vapour and gases from the solids channel comprises a vapour outlet in the solids channel, a pump and a receiving tank for collecting condensate, gases and vapours from the pump.

4. The apparatus of claim 3 wherein the pump is a cone jet pump.

5. The apparatus of claim 3 wherein the receiving tank has an internal cooler, at least one fluid outlet, and a gas outlet.

6. The apparatus of claim 1 wherein the auger comprises a discontinuous blade disposed about the centre shaft.

7. The apparatus of claim 6 wherein the discontinuous blade comprises a plurality of paddles angled relative to a plane perpendicular to a longitudinal axis of the auger.

8. The apparatus of claim 5 further comprising a gas scrubbing system for scrubbing gases and vapours leaving the gas outlet in the receiving tank with a caustic solution.

9. The apparatus of claim 1 further comprising an electrical generator operatively connected to at least one electric heating element associated with either the separator or the exhaust gas conduit.

10. An apparatus for cleaning particulate solids mixed with a liquid hydrocarbon comprising:
(a) an elongate separator having a solids inlet at one end and a solids outlet at a second end;
(b) means for heating the separator;
(c) an auger disposed within the separator, said auger comprising a discontinuous blade;
(d) means for rotating the auger;
(d) a vapour outlet for collecting and removing gases and vapours from within the separator.

11. The apparatus of claim 10 wherein the discontinuous blade comprises a plurality of paddles angled relative to a plane perpendicular to the longitudinal axis of the auger.

12. A method of cleaning particulate solids mixed with a liquid hydrocarbon, comprising the steps of:
(a) providing an elongate separator defining a solids channel and having an augur disposed within the channel;
(b) actuating the augur to push solids through the solids channel while heating the solids at the same time to produce hydrocarbon vapour, wherein the solids are heated directly or indirectly by exhaust gas from an internal combustion engine or electrical heating elements or both;
(c) collecting the hydrocarbon vapour by creating a partial vacuum within the solids channel and quenching the vapour with a water spray;
(d) collecting uncondensed gases and liquids from step (c), and separately collecting liquid hydrocarbons and water;
(e) recirculating water from step (d) to step (c).

13. The method of claim 12 wherein the solids are heated by exhaust gas from an internal combustion engine which is routed through the solids channel or through the augur itself, or both.

14. The method of claim 13 wherein the internal combustion engine actuates an electrical generator operatively connected to electric heating elements used to directly or indirectly heat the solids.

15. The method of claim 12 wherein the uncondensed gases are treated in a spray tower to remove particulate matter and gas emissions.
